(19) United States
(12) Patent Application Publication
(10) Pub. No.: US 2011/0208559 A1
(43) Pub. Date: Aug. 25, 2011

(54) Automatic Management of Networked Publisher-Subscriber Relationships

(76) Inventors: Marcus Fontoura, Sunnyvale, CA (US); Sergei Vassilvitskii, New York, NY (US); Jayavel Shanmugasundaram, Santa Clara, CA (US); Andrei Broder, Menlo Park, CA (US); Shirshanka Das, Santa Clara, CA (US); Bhaskar Ghosh, Palo Alto, CA (US); Vanja Josifovski, Los Gatos, CA (US)

(21) Appl. No.: 12/711,873

(22) Filed: Feb. 24, 2010

(51) Int. Cl. G06Q 10/00; G06Q 50/00; G06T 11/20

(52) U.S. Cl. 705/7.26; 345/440; 705/7.29

(57) ABSTRACT

Automatic management of networked publisher-subscriber relationships in an advertising server network. The method comprises steps for constructing a directed graph representation comprising at least one publisher node (e.g. an Internet property), at least one subscriber node (e.g. an Internet advertiser), at least one intermediary node (e.g. an Internet advertising agent), and at least one edge (e.g. an advertising target predicate) wherein any one of the edges is directly associated with at least one target predicate. The directed graph representation is used in conjunction with an inverted index for retrieving a valid node list comprising only nodes having at least one target predicate that matches at least one event predicate. The event predicate (as well as any target predicate) is any arbitrarily complex Boolean expression, and is used in producing a result node list comprising only nodes that concurrently match the event predicate with an advertising target predicate and are reachable.

### FIELD OF THE INVENTION

The present invention is directed towards automatic management of networked publisher-subscriber relationships used in online advertising, based on validity and reachability characteristics.

### BACKGROUND OF THE INVENTION

The marketing of products and services over the internet through advertisements is big business. Advertising over the internet seeks to reach individuals within a target set having very specific target predicates (e.g. male, age 40-48, graduate of Stanford, living in California or New York, etc). This targeting of very specific demographics is in significant contrast to print and television advertisements that are generally capable only to reach an audience within some broad, general demographics (e.g. living in the vicinity of Los Angeles, or living in the vicinity of New York City, etc).

Advertisers have long relied on advertising agents to manage the advertiser's campaigns, including reach and spend. Moreover an agent may itself use other agents, and any agent may place orders with ad networks, and an ad network may participate with others via an advertising exchange. In the context of internet advertising where an advertiser seeks to manage advertising spend, the task of the agent (or agents) can become very complex very quickly, possibly involving tens, hundreds, even thousands of entities (e.g. web publishers, other agents, advertising networks, etc) interconnected via relationships (e.g. business relationships, delivery contract terms, etc).

Thus, a solution for efficiently matching an advertiser's target demographics to a highly specific event raised by an Internet publisher is needed. In an exemplary advertising exchange, an advertiser may have relationships with multiple agencies, and an agency may have relationships with multiple publishers. Similar to the case of other commercial exchanges, the operation of the advertising exchange seeks to correlate sellers with buyers, even in the case that a seller and/or buyer is represented by an intermediary such as an agent. Thus a networked advertising exchange seeks to correlate relationships between buyers (e.g. advertisers), sellers (e.g. publishers), and intermediaries (e.g. agents). Thus a networked advertising exchange seeks to correlate relationships between buyers (e.g. subscribers), sellers (e.g. publishers), and agents (e.g. intermediaries).

Other automated features and advantages of the present invention will be apparent from the accompanying drawings and from the detailed description that follows below.

### SUMMARY OF THE INVENTION

Systems, methods and techniques for automatic management of networked publisher-subscriber relationships in an advertising server network. The method comprises steps for constructing a directed graph representation comprising at least one publisher node (e.g. an Internet property), at least one subscriber node (e.g. an Internet advertiser), at least one intermediary node (e.g. an Internet advertising agent), and at least one edge (e.g. an advertising target predicate) wherein any one of the edges is directly associated with at least one target predicate. The directed graph representation is used in conjunction with an inverted index for retrieving a valid node list comprising only nodes having at least one target predicate that matches at least one event predicate. The event predicate (as well as any target predicate) is any arbitrarily complex Boolean expression, and is used in retrieving and producing a result node list comprising only nodes that concurrently match the event predicate with an advertising target predicate and are reachable. Systems may include techniques for skipping certain retrievals such that the process for producing the results node list does not evaluate a valid node from the valid node list when the valid node is unreachable. Techniques are provided for labeling nodes of the directed graph representation, including labeling of graphs that contains cyclic subgraphs (e.g. using a two-part labeling scheme for condensed directed graph representations).

### BRIEF DESCRIPTION OF THE DRAWINGS

The novel features of the invention are set forth in the appended claims. However, for purpose of explanation, several embodiments of the invention are set forth in the following figures.

FIG. 1 depicts an advertising server network environment including a module for automatic management of networked publisher-subscriber relationships in which some embodiments operate.

FIG. 2A shows an advertising network environments depicted as a graph.

FIG. 2B shows the graph of FIG. 2A, and includes labeling of the source node and destination node.

FIG. 2C shows an advertising network environment including an intermediary, in which some embodiments operate.

FIG. 2D shows advertising network environments, each environment showing a path from a buyer to a seller through an intermediary, in which some embodiments operate.

FIG. 2E shows advertising network subnets, each subnets showing a path from a buyer to a seller through an intermediary, and including a representation of contracts, in which some embodiments operate.

FIG. 3 depicts a computer-readable graph comprising a directed graph representation having three types of nodes, in which some embodiments operate.

FIG. 4 is a protocol exchange for a system to perform certain functions for automatic management of networked publisher-subscriber relationships, according to one embodiment.

FIG. 5 shows an architecture for a computer-implemented method for automatic management of networked publisher-subscriber relationships, according to one embodiment.

FIG. 6 shows a directed acyclic graph where each node is annotated with its node ID, according to one embodiment.

FIG. 7 shows a graph containing cyclic subgraphs where each node is annotated with a randomly-selected node ID, according to one embodiment.

FIG. 8 shows a graph containing cyclic subgraphs where each node is annotated with a two-part node ID, according to one embodiment.

FIG. 9 shows an index with target predicates in the form of an inverted index, according to one embodiment.

FIG. 10 depicts a block diagram of a system for automatic management of networked publisher-subscriber relationships, in accordance with one embodiment of the invention.

FIG. 11 depicts a block diagram of a system to perform certain functions of an advertising server network, in accordance with one embodiment of the invention.

FIG. 12 is a diagrammatic representation of a machine in the exemplary form of a computer system, within which a set of instructions may be executed, according to one embodiment.

### DETAILED DESCRIPTION

A networked advertising exchange seeks to correlate relationships between buyers (e.g. subscribers), sellers (e.g. publishers), and agents (e.g. intermediaries). In the context of an Internet advertising, such relationships, inter-relationships, reciprocal relationships, etc. may be complex. In order to aid in the management of such relationships, an advertising exchange connects publishers to advertisers through advertising networks. Advertising networks enable publishers to reach a wider set of advertisers. Every time a publisher web page is visited, an advertising opportunity arises. At that time, an event from the publisher is generated indicating the event predicates for the opportunity. Such event predicates can include information about the page (such as the page content and its main topics), information about the available advertising slots (number of ads in the page and their maximum dimensions in pixels), and information about the user (such as user attributes and geographic location). Also, each ad network and advertiser in the system may specify target attributes, constraining the types of opportunities they are interested in. For instance, an ad network may be interested only in traffic from sports and finance pages with users older than 30.

Within the context of systems for online advertising, an advertiser seeks to present the advertiser's advertisement or message within content such as an online publication (e.g. Yahoo Autos) that is relevant to a particular internet user. For example, a manufacturer of hybrid motor vehicles (e.g. Ford) might establish an advertising campaign that attempts to place the manufacturer's advertisement on the same page as a Yahoo.com./autos search results page resulting from a search using the keyword “hybrid”. Matching an advertisement to a page to be presented to a particular internet user is facilitated by a network of publishers (e.g. Yahoo!) coordinated with a network of subscribers (e.g. advertisers and/or their brokers). Various relationships within such a network of networks may be represented by a graph, where each node on a graph is either a publisher (e.g. an Internet publisher such as Yahoo!), or an advertiser (e.g. a company an such as Ford), or an intermediary (e.g. a broker such as Satchi & Satchi), and where a node is connected to another node via an edge indicating a relationship (e.g. a business relationship, a contract, a revenue sharing agreement, a payment promissory, etc). The occurrence of an opportunity to present to a particular user an advertisement or message on a publisher's page (i.e. an impression opportunity) may be considered an impression opportunity event. At the occurrence of such an impression opportunity event, any/all of the advertisers or intermediaries might wish to be notified of the existence of the event. In some cases, an advertiser might be selective, and wish to be notified of the existence of an event only under certain circumstances (e.g. the internet user is in the age group 24-25 and the internet user has a credit rating within some range).

The single appearance of an advertisement on a web page is known as an online advertisement impression. Each time a web page is requested by a user via the internet represents an impression opportunity to display an advertisement in some portion of the web page (e.g. a “slot” or “spot”) to the individual internet user. Often, there may be significant competition among advertisers for a particular impression opportunity, i.e. to be the one to provide that advertisement impression to the individual internet user.

To participate in this competition, some advertisers define one or more campaigns, including a subscription (i.e. authorization) to bid on certain impression opportunities (e.g. authorization to bid in an auction) in the hope of winning the competition. An advertiser may specify desired targeting criteria (e.g. target predicates) in the subscription definition, which targeting criteria may include a keyword, multiple keywords, key phrases, or other targeting criteria. For example, an advertiser or agent (i.e. subscriber) may wish to present advertising messages to users who visit a particular web page from a particular publisher (e.g. Yahoo! Sports).

In modern internet advertising systems, competition for showing an advertiser's message in an impression is often resolved by an auction, and the winning bidder's advertisement(s) and/or message(s) are shown in the available spaces within the impression. Indeed online advertising and marketing campaigns often rely, at least partially, on an auction process where any number of subscribers book contracts to authorize highest bids corresponding to targeting characteristics (e.g. a search keyword, a set of keywords, bid phrases, or various target predicates). Considering that (1) the actual existence of a web page impression opportunity event suited for displaying an advertisement is not known until the user clicks on a link pointing to the subject web page, (2) the entire auction/bidding process for selecting advertisements corresponding to notified/winning subscribers must complete before the web page is actually displayed, and (3) there may be many subscribers to a particular property/demographic, it then becomes clear that the identification of subscribers (and notification as to the event) should be carried out automatically.

### Overview of Networked Systems for Online Advertising

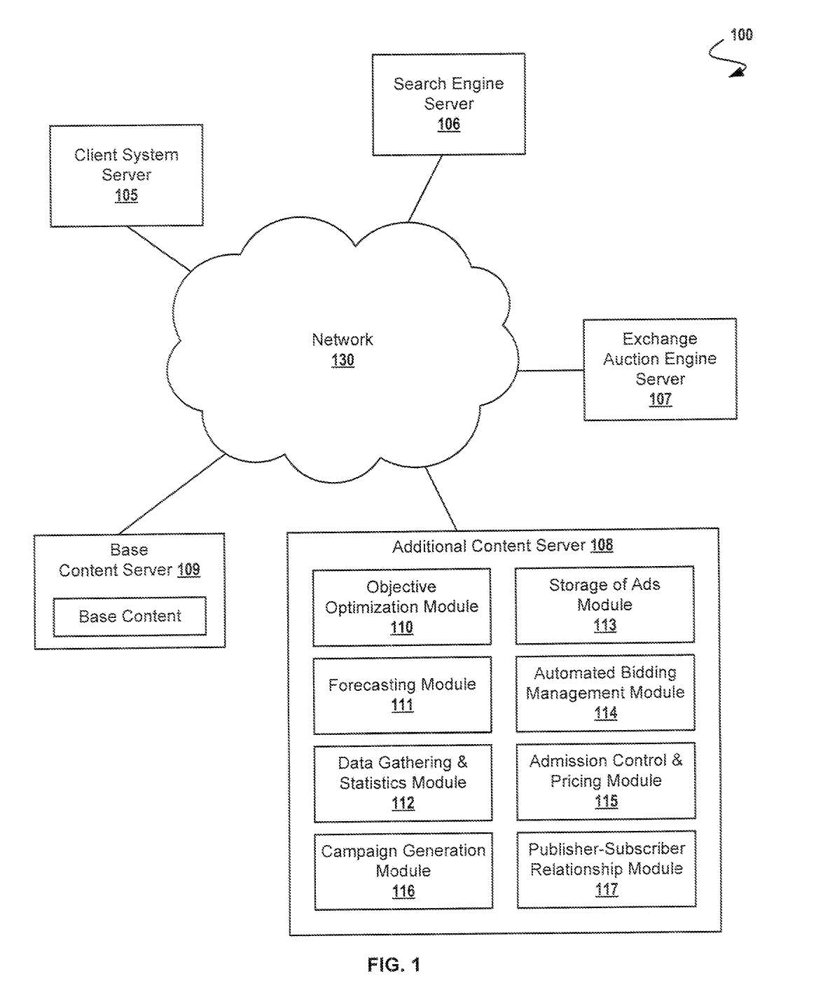

FIG. 1 depicts an advertising server network environment including a module for automatic management of networked publisher-subscriber relationships in which some embodiments operate. In the context of internet advertising, placement of advertisements within an internet environment (e.g. system 100 of FIG. 1) has become common. By way of a simplified description, an internet advertiser may select a particular property (e.g. Yahoo.com/Finance, or Yahoo.com/Search), and may create an advertisement such that whenever any internet user, via a client system 105 renders the web page from the selected property, possibly using a search engine server 106, the advertisement is composited on a web page by one or more servers (e.g. base content server 109, additional content server 108) for delivery to a client system 105 over a network 130. Given this generalized delivery model, and using techniques disclosed herein, sophisticated online advertising might be practiced. More particularly, an advertising campaign might include highly-customized advertisements delivered to a user corresponding to highly-specific targeting constraints. Again referring to FIG. 1, an internet property (e.g. an internet property hosted on a base content server 109) might be able to measure the number of visitors that have any arbitrary characteristic, demographic, targeting constraints, or attribute, possibly using an additional content server 108 in conjunction with a data gathering and statistics module 112. Thus, an internet user might be ‘known’ in quite some detail as pertains to a wide range of targeting constraints or other attributes.

Therefore, multiple competing advertisers might elect to bid in a market via an exchange auction engine server 107 in order to win the most prominent spot, or an advertiser might enter into a contract (e.g. with the internet property, or with an advertising agency, or with an advertising network, etc) to purchase the desired spots for some time duration (e.g. all top spots in all impressions of the web page empirestate.com/hotels for all of 2010). Such an arrangement, and variants as used herein, is termed a contract.

In embodiments of the system 100, components of the additional content server perform processing such that, given an advertisement opportunity (e.g. an impression opportunity profile predicate), processing determines which (if any) contract(s) match the advertisement opportunity. In some embodiments, the system 100 might host a variety of modules to serve management and control operations (e.g. objective optimization module 110, forecasting module 111, data gathering and statistics module 112, storage of advertisements module 113, automated bidding management module 114, admission control and pricing module 115, campaign generation module 116, a publisher-subscriber relationship module 117, etc) pertinent to contract matching and delivery methods. In particular, the modules, network links, algorithms, and data structures embodied within the system 100 might be specialized so as to perform a particular function or group of functions reliably while observing capacity and performance requirements. For example, an additional content server 108, possibly in conjunction with a publisher-subscriber relationship module 117 might be employed to perform automatic management of networked publisher-subscriber relationships within an advertising exchange having buyers, sellers, and agents.

Agencies as discussed herein include real companies with real people making decisions and taking action on behalf of the agency's clients. Agencies can enter into business deals with other entities. Using the techniques described herein, an agency's business deals (i.e. contracts) can be represented as data items to be shared among the entities involved in a given transaction. Further, agencies seek and establish contracts with other entities on the advertising exchange. As used within the context of the embodiments of the invention herein, these contracts allow agencies to act as a proxy on behalf of their customers. Embodiments of the invention herein provide for representing an agency as an entity on the advertising exchange, and thus, as an entity-on-exchange, the agency may participate with the advertising exchange (i.e. perform transactions through or with other advertising exchange seat-holders).

Other embodiments provide for agencies to perform regular publishing and subscribing activities on or through the advertising exchange within the limits of permissions granted to the agency specifically for the purpose of performing such activities.

### Definitions and Depiction of Entities on an Advertising Exchange: Network Graphs, Directed Graphs

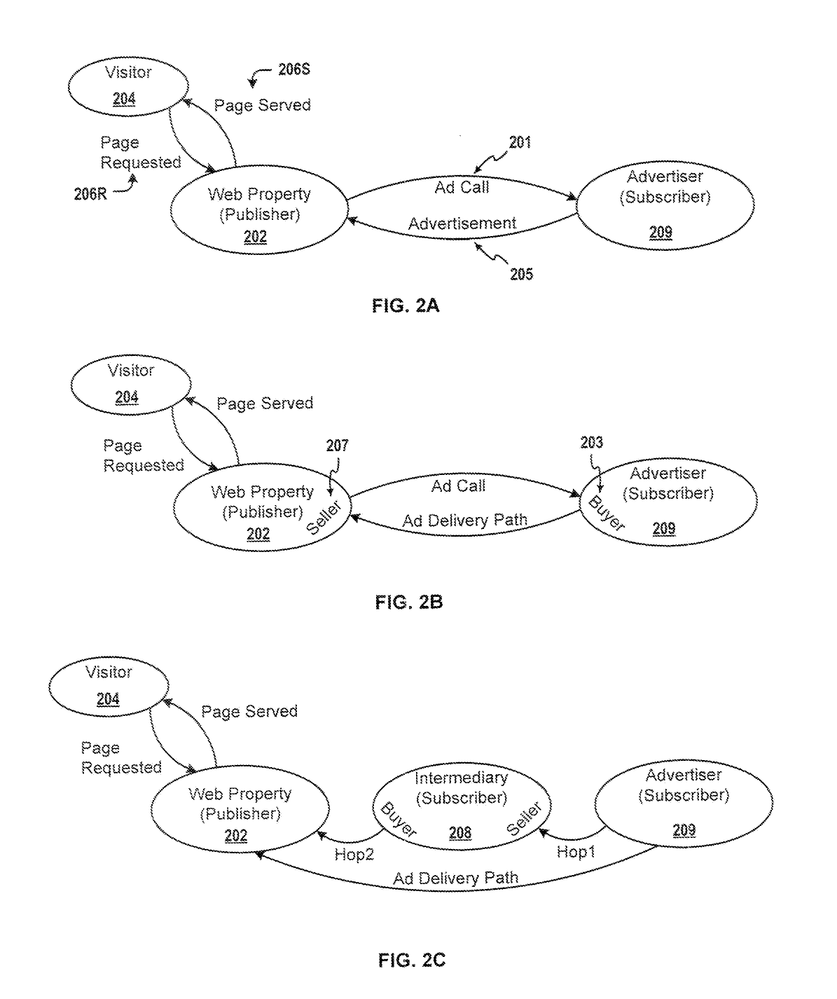

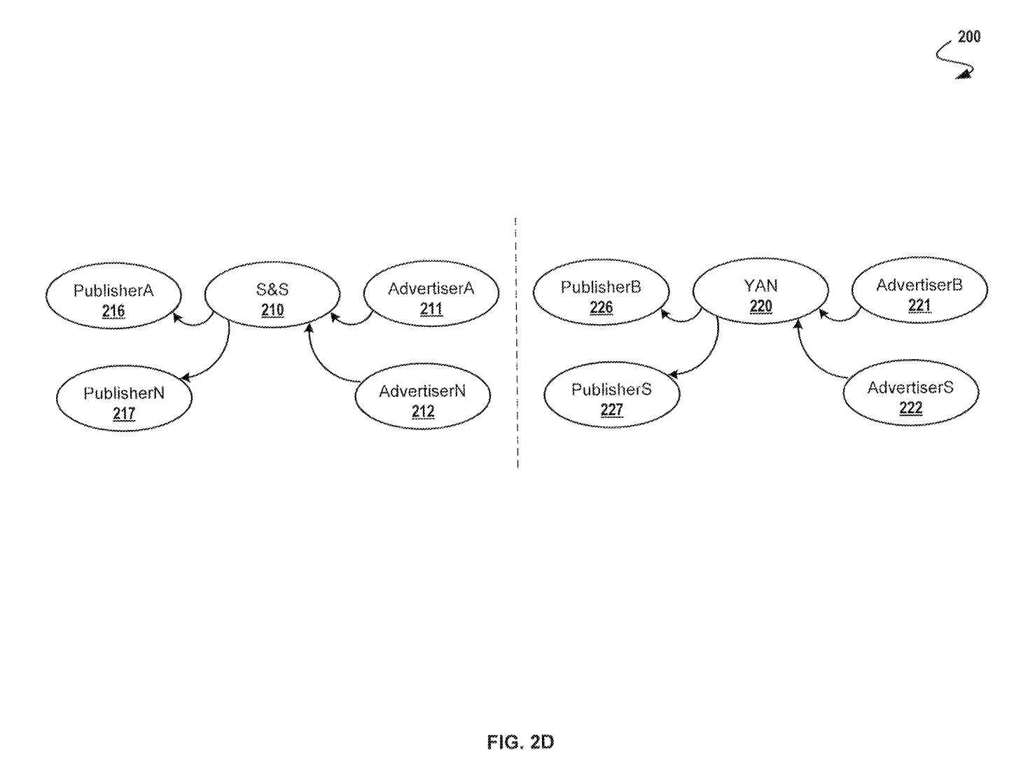

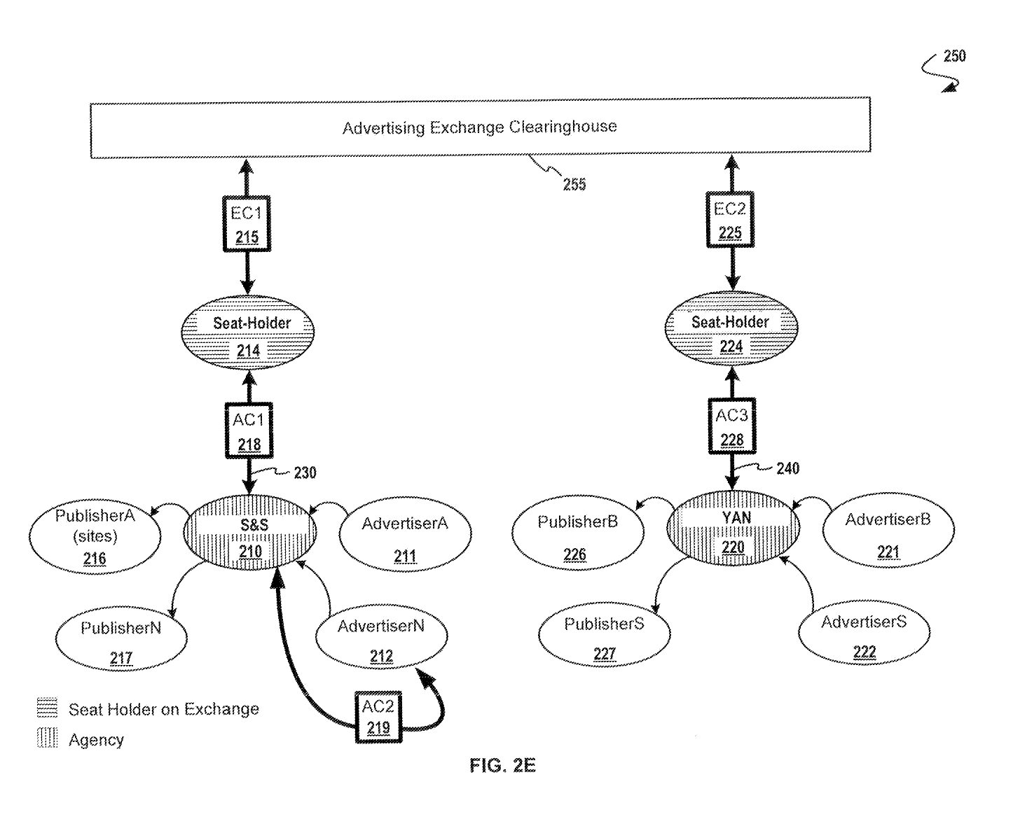

FIG. 2A shows an advertising network environment depicted as a directed graph wherein a publisher 202 of a site engages in serving pages to a web page visitor 204 (via exchange of a page requested 206R, and a page served 206S). Also shown is a publisher's interaction with an advertiser-subscriber 209. In this simplified model, a visitor requests a page from the publisher 202. The publisher performs an ad call 201 to an advertiser-subscriber 209, and the advertiser-subscriber in turn supplies an advertisement 205 to the publisher 202. The page requested by the visitor is composited to include the advertisement, and the served page 206S is served to the visitor.

FIG. 2B shows the graph of FIG. 2A, and includes labeling of the source node (buyer 203) and destination node (seller 207) pertaining to the graph edge labeled as ad delivery path, which ad delivery path generally begins with a buyer and ends with a seller.

FIG. 2C shows an advertising network environment including an intermediary 208. In this environment, the intermediary 208 acts as both a buyer and seller. As shown, the ad delivery path begins with the advertiser-subscriber 209, and ends with the publisher 202 as in FIG. 2A and FIG. 2B, and in this case, the ad delivery path is accomplished via two hops, hop1 and hop2.

So, with the above definitions, and for the purposes of understanding the disclosure herein, an ad delivery transaction on the advertising exchange can be represented on a directed graph such as is shown in FIG. 2A, FIG. 2B, and FIG. 2C. Consider the following assertions:
An ad delivery transaction originates from an entity (buyer) and terminates at an entity (seller). The directed edge is referred to as a hop. One or more hops between graph nodes is a path.
A path may traverse through zero or more other nodes (e.g. entities) on the advertising exchange; each such node is considered to be an intermediary in the transaction.
A path may comprise several sub-paths or hops; each hop has a buyer end-point at the beginning (an entity) and a seller end-point (another entity) at the end.
The buyer end-point of the first such hop is termed the original buyer in the ad delivery transaction.
The seller end-point of the last hop is termed the original seller.
The transactions accomplished between the original seller and the original buyer are termed ad delivery transactions.

Now, for any ad delivery transaction, there may be zero, one, or more hops, and as introduced above, each hop has a buyer and a seller and may also involve an intermediary (e.g. an agency). Accordingly, a hop represents a transactional relationship between a buyer and a seller, even if not the original buyer and original seller. Such relationships may include a link, and possibly also a deal. Collectively these relationships may be represented on/in the directed graph representations.

### Agency Role and Actions on the Advertising Exchange

Agencies are entities on the advertising exchange that perform activities on behalf of their customers. These activities include actions to:
Place orders
Manage campaigns
Create ads
Manage links
Manage deals
Manage sites
View and interpret reports
Participate in billing and payment

As are described in exemplary embodiments, an agency may operate as a reseller, under which model an agency gets billed by its supplier(s), and in turn bills its customers for delivery. In the reverse sense of a reseller, an agency gets paid by its customer, and in turn pays its supplier. Such transactions may be recorded at each occurrence of an ad delivery, and may be summarized in a periodic statement, which statement may include detailed information of any number of transactions, or groups of transactions, or invoices.

Also, as are described in further exemplary embodiments, an agency may operate as a pure agency, under which model an agency does not get billed by its supplier(s); instead the pure agency's clients transact directly with the supplier. In this scenario, the pure agency receives remuneration via an agency fee (e.g. broker fee).

In various cases, the agency fee is processed as a separate transaction. Also, in various cases, including both agency as reseller and also agency as pure agency, revenue sharing may be processed as a separate transaction.

Agencies may want to cooperate with other agencies, and may wish to establish interrelationships with other agencies or, more generally, may wish to establish interrelationships with other agencies at large or, still more generally, may wish to establish interrelationships and/or engage in transactions with other entities (i.e. beyond just agencies) and may thus wish to become seat-holders on an advertising exchange.

### Advertising Exchange Concepts and Actions

An advertising exchange can be formed comprising any group of entities involved in the trading/matching of advertising placement opportunities, and advertising to fill such placement opportunities. Inasmuch as an agency performs actions on behalf of other entities on the exchange, various instruments are used in the provision of agency services. For example, agency-contracts, or links:
Agency-Contracts: Agencies can establish an agency-contract (“AC” or agency contract) with a client. One or more agency-contracts might be associated with a given link. For example, Nike Sports might enter into an agency-contract with agency MadisonAvenue99 for placement of certain ads on a particular internet property. Additionally, Nike Sports might enter into a second agency-contract with MadisonAvenue99 for placement of certain ads on a different internet property. In some cases, agency-contracts define agency fees, and/or revenue sharing particulars, and/or broker fees to be paid to agencies.
Links: Agencies can establish links with entities on the exchange. Links, and their representation in the directed graphs, merely indicate the existence of some relationship, which relationship might involve a monetary transaction, for example an agency (e.g. the ad agency “MadisonAvenue99 ”) might agree to handle ads for a buyer (e.g. “Nike Sports”), and MadisonAvenue99 might agree to place ads on an internet property on behalf of the buyer (e.g. SI.com). In such a case, there is a link between Nike Sports (the original buyer in this example) and MadisonAvenue99 (the agency). Also in this example, there is a link between MadisonAvenue99 and SI.com (the original seller).

### Subnets and Exchange: Concepts and Actions

FIG. 2D shows advertising network environments, each showing a path from a buyer to a seller through an intermediary, in which some embodiments operate. Depicted is an exemplary networked publisher-subscriber system in which intermediary S&S 210 and intermediary YAN 220 each operate an ad network. As shown on the left side of advertising network environments 200, an ad subnet is formed by an agency S&S 210 together with its advertisers (AdvertiserA 211, AdvertiserN 212) and its publishers (PublisherA 216, PublisherN 217). On the right side is a second ad subnet, formed by an agency (intermediary YAN 220) together with its advertisers (AdvertiserB 221, AdvertiserS 222) and its publishers (PublisherB 226, PublisherS 227). Each agency is able to perform agency functions for the agencies' respective customers and with the agencies' affiliated publishers. However, as shown there are no connections (e.g. graph edges, contracts, links, etc) between the two agencies (i.e. intermediary S&S 210 and intermediary YAN 220). This situation exemplifies the agency-within-ad-network model. Thus, in this example, if PublisherA 216 had an ad call suited for a sports-related advertiser, it would be able to receive an advertisement from the advertisers within the subnet (i.e. AdvertiserA 211 or AdvertiserN 212), but not from advertisers in another subnet (e.g. not from AdvertiserB 221 or AdvertiserS 222). Of course an agency is free to establish new agency relationships with any advertiser, and thereby establish a new advertiser in the subnet; however, establishing such a relationship is human-resource and -time intensive. So, clearly in absence of a relationship (for example) between AdvertiserS 222 and PublisherA 216, such a relationship—possibly facilitated via an ad call from PublisherA 216—cannot be fulfilled by an advertisement from AdvertiserS 222.

FIG. 2E shows advertising network subnets, each subnet showing a path from a buyer to a seller through an intermediary, and including a representation of contracts, in which some embodiments may operate. Depicted is an exemplary advertising exchange system 250 in which two agencies 210, 220 are each affiliated with a seat-holder, 214 and 224 respectively, and within which advertising exchange system 250 each agency operates an ad network. The agencies, namely S&S agency 210 and YAN agency 220, are each affiliated with seat-holders on an advertising exchange clearinghouse 255, as indicated by the AC1 agency contract link 230 and the AC3 agency contract link 240, respectively. Becoming a seat-holder on an advertising exchange clearinghouse 255 might involve entering into an exchange contract 215 and 225 (e.g. exchange agreement, exchange membership, EC, etc), respectively. Such an exchange contract might take the form of a legal instrument signed by a duly appointed representative of each of the entities, and the signature on the legal instrument may be obtained in hand and ink, or may be obtained with a virgule signature. In exemplary cases, the exchange contract subsumes several machine-readable data items (e.g. an electronic form, a data record, a bitmask, etc), and such machine-readable data items can be retrieved by other exchange seat-holders. FIG. 2E also shows an agency-contract AC1 218, as an agency-contract data item shared by the agency 210 and a seat holder 214. Similarly, FIG. 2E also shows an agency-contract AC3 228, as an agency-contract data item shared by the agency 220 and seat-holder 224. Still more, FIG. 2E also shows an agency-contract AC2 219, as an agency-contract data item shared by the AdvertiserN 212 and agency 210. More generally, any path in a graph (e.g. graph edge) from a buyer to a seller may convey any arbitrary characteristics (e.g. target predicates) of the relationship.

### Overview of Systems and Methods for Management of Networked Publisher-Subscriber Relationships

In some aspects, the relationship between a publisher and an advertiser or intermediaries is akin to the relationship between a print media publisher and a print media subscriber, where the subscriber wishes only to receive certain specific publications from the publisher (e.g. only the Sunday morning edition of the publisher's daily newspaper). Systems exhibiting such publisher/subscriber relationships may be termed publisher-subscriber systems.

Disclosed herein are a new class of publisher-subscriber systems (termed networked publisher-subscriber systems) and techniques for automatic management of networked publisher-subscriber relationships. In the embodiments disclosed herein, publishers and subscribers are connected through a network of intermediary nodes in a computer-readable graph.

Now, applying the concepts of a publisher-subscriber system, the advertising exchange is responsible for notifying all subscribers to a particular type of opportunity event of the existence of a particular opportunity event instance of the subscribed-to type. A valid subscriber includes advertisers for which there is a contract (or other description) of a willingness to bid on a given ad opportunity (e.g. an ad opportunity with an event predicate matching contractual target predicates or other specifications). Moreover, a “valid” advertiser must be “reachable” via at least one valid path from the publisher that originated the opportunity (i.e. a direct relationship as shown in FIG. 2A, or a path through an intermediary as shown in FIG. 2C). More formally, given a network of nodes (possibly including intermediary nodes) in the form of a computer-readable graph, if at least one path exists such that each node in the path (whether intermediary or not) can satisfy its target predicate(s), then there exists a path making each node in the path reachable. The set of valid subscribers, once notified, may then want to compete for that ad opportunity. In some embodiments, the desire (e.g. to compete for an ad opportunity) of a subscriber generates a candidate pair in a form such as {ad, bid value}, where bid value is the amount the advertiser is willing to pay to have its ad shown. After all such candidate pairs have been codified (e.g. a form such as {ad, bid value}), the advertising exchange selects the most suitable ads for the opportunity using an appropriate selection mechanism (e.g. selection based on factors to maximize the revenue for the publisher).

Of course, a publisher-subscriber relationship module 117 might implement algorithms for efficient query evaluation that work for any directed graph network. As the number of nodes within a publisher-subscriber system increases, and as the specificity of the relationship (e.g. target predicates) of the subscriber to the publisher increases, operators of publisher-subscriber systems seek techniques to efficiently match event predicates to a set of subscribers that are interested (by virtue of their corresponding target predicates) in these event predicates. In general, when an event is generated, an efficient publisher-subscriber system might quickly identify all matches.

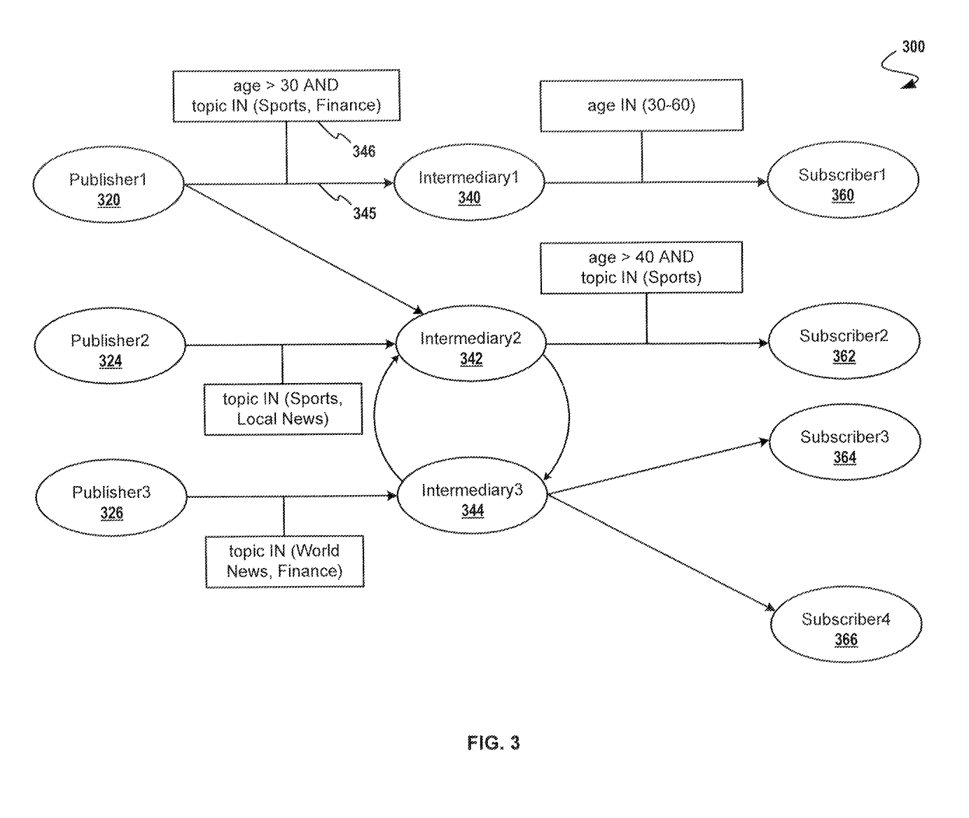

FIG. 3 depicts a computer-readable graph comprising a directed graph representation system 300 having three types of nodes: publisher nodes 320, 324, 326, intermediary nodes 340, 342, 344, and advertiser nodes 360, 362, 364, 366. Relationships between nodes are shown as edges, and an edge may convey characteristics of the relationship (e.g. an advertiser's contractually-stated desire to present an advertisement to an internet user with particular targeting constraints, target predicates, and/or demographics). Each node in the computer-readable graph may represent a publisher node, an intermediary node, or an advertiser node. As shown and described in this embodiment, nodes with no incoming edges are considered to be publishers and nodes with no outgoing edges are considered to be subscribers. Nodes that possess both incoming edges as well as outgoing edges are considered intermediaries. A path is traversed from a node to another node via edges. A path may traverse any plurality of nodes.

Referring again to FIG. 3, events (not shown) from a publisher p can only be delivered to subscribers that have at least one path from p in the graph. Moreover, the path from p satisfies the characteristics of the relationship (e.g. satisfy specified target predicates) between the nodes connected by an edge.

### Internet Advertising Exchange

In one embodiment, one or more internet advertising networks connect publishers to advertisers, possibly through an advertising exchange clearinghouse 255). For example, and as shown in FIG. 3, the three publishers Publisher1, Publisher2, and Publisher3 are all connected to advertisers Advertiser1, Advertiser2, Advertiser3, and Advertiser4 through advertising networks Intermediary1, Intermediary2, and Intermediary3 (possibly using an advertising exchange clearinghouse 255). Such an arrangement enables publishers to reach a wider set of advertisers without requiring a direct relationship with a particular publisher. Thus, in the embodiment of FIG. 3, the three exchange networks Intermediary1, Intermediary2, and Intermediary3 provide the relationships that then allows the three publishers Publisher1, Publisher2, and Publisher3 to have access to the four available advertisers Advertiser1, Advertiser2, Advertiser3, and Advertiser4 in the system. That is, assuming unconstrained edges, the three publishers have access to the four available advertisers in the system. As a specific example, Publisher1 may reach Advertiser4 via Intermediary2 and Intermediary3, even though Publisher1 does not have any direct relationship with Advertiser4.

Further describing the computer-readable graph of FIG. 3, the relationships between nodes are shown as edges. The relationships are expressed as a predicate (e.g. an expression of targeting attributes), and one or more target predicates 346 may be directly associated with the edge 345 (as shown). The target predicates shown are purely illustrative, and any number of different and/or more complex or more specific target predicates may be attached to an edge. Indeed, various embodiments, include complex predicates, possibly stated as an arbitrarily complex Boolean expression. Moreover, the graphical representation of FIG. 3 is just one of many possible embodiments of a directed graph representation comprising one or more publisher nodes (e.g. publisher node 320), connected to one or more subscriber nodes (e.g. subscriber node 360), and further connected to one or more intermediary nodes (e.g. intermediary node 340). Any edge (whether represented as a graphic edge on a drawing or represented as a directed relationship between nodes in a data structure within a computer memory) may be directly associated with at least one target predicate.

### Operation of a Networked Publisher-Subscriber System in an Advertising Network

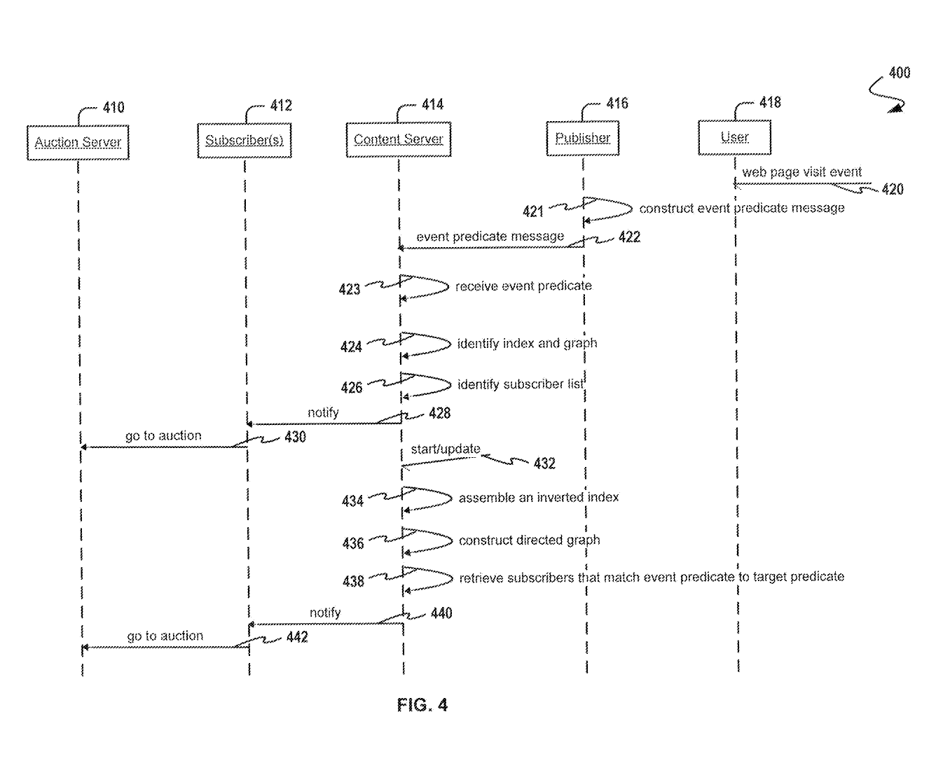

FIG. 4 is a protocol exchange for a system to perform certain functions for automatic management of networked publisher-subscriber relationships. As an option, the present protocol exchange system 400 may be implemented in the context of the architecture and functionality of the embodiments described herein. Of course, however, the protocol exchange system 400 or any operation therein may be carried out in any desired environment. As shown, the protocol exchange system 400 comprises a series of operations used in the automatic management of networked publisher-subscriber relationships.

An advertising impression opportunity arises at such a time when a publisher's web page is visited (see web page visit event 420) by an internet user 418. Using the systems and method described herein, at that time, a publisher (or proxy for a publisher) may construct an event predicate message (see operation 421). As shown, an event from the publisher is generated (see event predicate message 422) indicating the target predicates for the opportunity. Such target predicates can include information about the page (such as the page content and its main topics), information about the available advertising slots (number of ads in the page and their maximum dimensions in pixels), and information about the user (such as user demographics and geographic location). The event predicate message 422 may be formatted for receiving the event predicate message at a server (e.g. content server). As previously described, each advertiser in the system may specify target predicates constraining the types of opportunities in which they are interested (and which attributes may be carried by any one or more advertising network nodes). For instance, an ad network may specialize only in trading in traffic related to sports and finance pages with users older than 30 (as is the case for Intermediary1 in FIG. 3). Continuing, content server 414 (e.g. an additional content server 108) may receive a event predicate, however transmitted (see operation 423), and the content server 414 may identify an inverted index and a graph representation (see operation 424), and then identify a list of subscriber(s) 412, which list comprises only reachable subscribers interested in at least one target predicate that matches at least one event predicate (see operation 426).

The advertising exchange is then responsible for notifying all valid advertisers for the given ad opportunity. Subscribers may then be notified (see message 428). Valid advertisers have at least one valid path from the publisher that originated the opportunity, meaning that the path exists and that each node in the path satisfies its targeting constraints. In the example of FIG. 3, if a user of age 35 visits a sports page from Publisher1, then Intermediary1, Intermediary2 and Advertiser1 would satisfy both the targeting and graph constraints for the event, and therefore Advertiser1 would be the only valid advertiser for the event.

Continuing the discussion of FIG. 4, the specific protocol exchange system 400 for a system to perform certain functions for automatic management of networked publisher-subscriber relationships might be further described as commencing upon a start event (see the asynchronous start event 432). Then a directed graph representation comprising (a) at least one publisher node (e.g. a node for publisher 416), (b) at least one subscriber node (e.g. a node for subscriber 412), and (c) at least one intermediary node (not shown) would be constructed in memory. The directed graph might contain at least one edge directly associated with at least one target predicate, for example resulting from the publisher's construction of an event predicate message (see operation 421). The protocol continues by identifying an index and graph (see operation 424) or, if needed, by assembling, in memory, an inverted index for retrieving a valid node list comprising only nodes that match an event predicate (see operation 434). Similarly, if needed, the protocol exchange system 400 continues by constructing, in memory, a directed graph for retrieving a valid node list comprising only nodes that are reachable (see operation 436). As shown, the content server 414 then retrieves a subset of subscribers (possibly in the form of a result node list) that comprises only subscribers that concurrently match the event predicate and are reachable (see message 438), then notifying subscribers (see message 440), which subscribers might then go to auction (see message 442) at an auction server 410. The specific steps for identifying only subscribers that concurrently match the event predicate and are also reachable are given in the algorithms presented farther below (e.g. Algorithm 1, Algorithm 2, Algorithm 3, and Algorithm 4).

Of course the described protocol is only one example of uses of an index, and a graph representation in conjunction with the algorithms. The notions herein described are also useful in other contexts, in particular for implementing a networked publisher-subscriber system in a social network.

### Operation of a Networked Publisher-Subscriber System in a Social Network

In social networks, users are connected to each other forming a connection graph (similar to the aforementioned directed graph). Consider a situation where every user subscribes and produces a stream of “interesting tidbits”. Such tidbits could be events (say music shows, theater shows, etc), news, books of interest, and so on. A user can choose to incorporate in their tidbits a collection of tidbits produced by other users in the network, but with some restrictions. For instance, a user may be only interested in tidbits related to theater shows. The operation of a networked publisher-subscriber system in this context needs to add to the user's collection all the tidbits that have a valid path from the tidbit publisher to the user and that satisfy the user's interest restrictions. The “status update” feature in Facebook can be viewed as a simplified version of the tidbit idea. In such a Facebook example, the status updates are delivered only to the immediate ‘friends’ of a user (i.e. only to users that are one hop away from the publishing user); users have limited control over which updates are determined as being in their interest and who should receive their updates. Using other social networking models such as Twitter, intermediate services can act as content dissemination nodes accumulating and redistributing tidbits (e.g. tweets) to interested subscribers.

### Generalization of a Networked Publisher-Subscriber System

Now, returning to disclosure of automatic management of networked publisher-subscriber relationships and applying the concepts of a publisher-subscriber system, the advertising exchange is responsible for notifying all reachable subscribers of the existence of a matching opportunity. One possible solution for this problem is to merely identify all subscribers for a particular event, and then to post-filter the results, discarding subscribers that do not have valid paths leading to them. This solution can be greatly improved by keeping track of node reachability while using an index to evaluate the target predicates. Given that the target predicates may include hundreds or thousands or more specific attributes to be evaluated, the computing complexity increases quickly as the number of subscribers to an event increases, thus a solution for efficiently matching a subscriber to a highly specific event (one specific event from among many millions of similar events) is needed.

One such solution uses an index structure that efficiently evaluates the target predicates, returning only subscribers to the event that satisfy the following:

A targeted interest, where the subscriber has a contract that matches the opportunity, and

Reachability, where there is at least one valid path from the publisher to the subscriber (possibly direct, or possibly involving one or more intermediaries).

In other words, in the setting of an advertising network exchange, a candidate subscriber is only a true subscriber if the subscriber has indeed expressed an interest in delivering an advertisement to the specific targeted opportunity, and also, the candidate subscriber has established some mechanism (e.g. contract with the publisher or a contract with one or more intermediaries) for data exchange pertaining to the specific targeted opportunity.

To verify reachability, the algorithms disclosed below use efficient access to the graph structure. In some cases, the graph can be stored in main memory. It is also possible in some cases to keep track of two sets of nodes during query evaluation. Specifically, the two sets of nodes are:

Reachable nodes, which are the nodes that are reachable from the publisher through at least one valid path, and

Valid nodes, which are the nodes for which their target predicates satisfy at least one given event predicate.

Some embodiments use an “online” breath-first search (BFS) from the publisher node to compute the reachable set using the nodes returned by the index as input. Every node returned by the index is valid with respect to its target predicates and, therefore, it is part of the valid set (by definition). Certain aspects of efficiency rely on the fact that the nodes that should be returned as valid and reachable subscribers are the nodes in the intersection of the reachable node set and valid node sets, i.e. the valid nodes that have at least one valid path leading to them.

### Apparatus for a Networked Publisher-Subscriber System in an Advertising Network

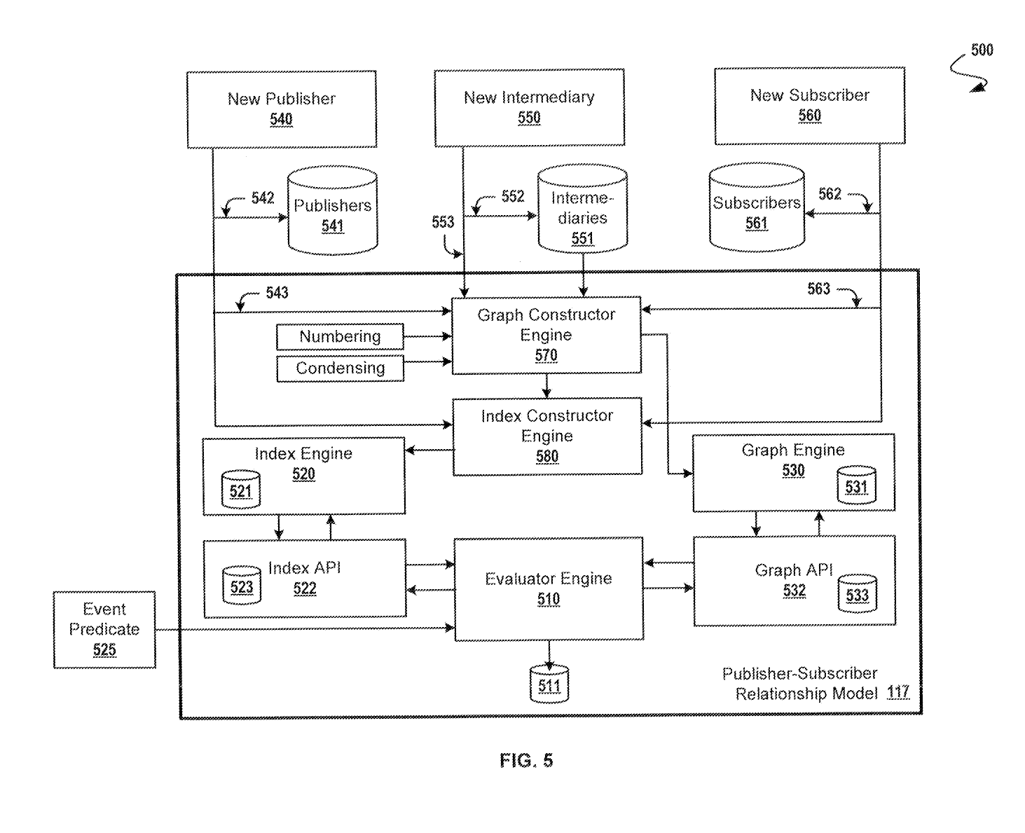

FIG. 5 shows an architecture for a computer-implemented method for automatic management of networked publisher-subscriber relationships. In this embodiment, the evaluator engine 510 uses both the index engine 520 and the graph engine 530 simultaneously to compute the set of valid and reachable subscribers for each event. The embodiment shown uses an index structure that provides an application programming interface (API), namely the index API 522, for retrieving the valid nodes for a given event. The graph engine 530 is responsible for returning the children of a given node. As shown, the evaluator engine 510 functions for computing the intersection of the reachable and valid nodes.

In exemplary embodiments, the structure of the graph is known a priori and the known structure of the graph can be exploited to speed up evaluation by skipping over nodes that are unreachable (see Algorithm 1, Algorithm 2, Algorithm 3, Algorithm 4).

Now further describing the embodiment of FIG. 5, shown is a publisher-subscriber relationship module 117 for implementing a (computer-implemented) method for automatic management of networked publisher-subscriber relationships. The publisher-subscriber relationship module 117 includes a graph engine 530 for constructing a directed graph representation 531. In exemplary cases, a directed graph representation comprises at least one publisher node (320), at least one advertiser node (360), and at least one intermediary node (350). Also, a directed graph representation 531 constructed by the graph engine 530 contains at least one edge (e.g. edge 345) that is directly associated with at least one target predicate (e.g. 346). The publisher-subscriber relationship module 117 also includes an index engine 520 for assembling an inverted index 521. In exemplary cases, the index engine 520 constructs an inverted index 521 for retrieving a valid node list 523, possibly using an index API 522 for communication (e.g. between the index engine 520 and the evaluator engine 510), whereby the valid node list 523 comprises only nodes that match at least one event predicate. In exemplary cases, the graph engine 530 constructs a directed graph representation 531 for retrieving a children, possibly using a graph API 532 for communication (e.g. between the graph engine 530 and the evaluator engine 510.The evaluator engine 510 serves for receiving an event predicate 525, and producing a result node list 511 comprising only nodes that concurrently match the event predicate and are reachable.

Algorithms for Evaluation of Valid and Reachable Subscribers using Graph Representations of the Network

The paragraphs presented below formalize the problem into mathematic representation, introduces algorithms for use on directed acyclic graphs (DAGs), and further develops algorithms for use on any input graph—acyclic or not. For directed acyclic graphs, a topological sort order of the graph aids to decide which nodes are unreachable (see Generalized Query Evaluation Algorithm for DAGs, presented below) without having to retrieve them from the index. In the case of general directed graphs with cycles (i.e. containing at least one cyclic subgraph), a condensation of the graph is formed by mapping each strongly connected component (SCC) into a single condensed node, then use the resulting condensed DAG to avoid retrieving from the index nodes that belong to unreachable SCCs.

Herein is discussed the algorithm for the special case of DAGs, showing how the graph structure allows for evaluation speed-up using skipping in the index. Subsequent sections describe modifications to the algorithms for use on any directed graph.

### Problem Formalization

The problem of query evaluation in networked publisher-subscriber systems consists of identifying the set of valid nodes in a network graph G, which are the subscribers to be notified for the event. Queries in this context are defined using two components

1. A start node s, representing the publisher, and

2. A set Q of labels representing the event.

A network may be modeled by a directed graph G=(N,E), with each node n ∈ N having an associated set of labels Lₙ corresponding to its target predicates. With respect to a matching function match(Q,Lₙ), a directed path P is defined to be valid for Q if P is a path in G and the set of labels Lₙ associated to every node n in P is valid for Q. The output of the system is defined as the set of nodes in G reachable from s via valid paths for Q. In this formalization of the problem the target predicates are placed on nodes. If, in another formalism, the target predicates were placed over an edge, the target predicates could be, for instance, mapped onto its destination node.

Generalized Query Evaluation Algorithm for DAGs The function match(Q,Lₙ) might be defined specifically for each application. For example, match(Q,Lₙ) could be defined with semantics as a “superset”, meaning that the set of labels Lₙ must be a superset of the labels in Q, which definition would represent AND queries as used in information retrieval systems. That is, every query label must be present in the qualifying documents. Alternatively, the function match(Q,Lₙ) might be defined with semantics as a “subset”, meaning that the target predicates specified for each node must be a subset of the event attributes (e.g. when a subscriber is interested in sports pages only and the event identifies a page as belonging to both the sports and news categories).

Consider the nodes and labels in Table 1. For query labels Q={A, B, C}, if the semantics is “superset”, only nodes 2 and 3 would be valid. On the other hand, if the semantics is “subset”, then only nodes 2, 5 and 6 would be considered valid.

TABLE 1
Nodes and targeting labels

| node # | Lₙ |
|---|---|
| 1 | {D} |
| 2 | {A, B, C} |
| 3 | {A, B, C, D} |
| 4 | {D, E} |
| 5 | {B} |
| 6 | {A, C} |

For purposes of the development of the algorithms below, it is reasonable to abstract away the details of the match(Q,Lₙ) function, and instead assume that:

(a) Each node has a unique node id, and

(b) There is an underlying index that returns matching nodes in order of their IDs.

The index engine 520 implements a getNextEntity(Q,n) function call which returns the next matching node with node ID of at least n. Considering the example from Table 1, getNextEntity(Q,3) would return 5 when the match(•,•) semantics is defined as a subset.

Given such an index engine 520, one possible algorithm is to first retrieve all of the matching nodes, and then compute the subset reachable from s in the graph induced by them. In the following subsections are presented algorithms for the evaluator engine 510 of FIG. 5. These algorithms combine the retrieval and reachability calculations, resulting in improved performance due to lower latency and the ability to skip in the index (for example, large sets of matching nodes not connected to s may be ignored).

Observe the following notation and the formalization of previously introduced concepts (in one special case, the graph G is a DAG):
Graph G=(N,E). The graph itself or some compact representation of the graph, or a representation returned via an API as shown connected to the graph engine 530 that efficiently returns the children of a node. In some cases, an efficient implementation of Cₙ={v ∈ N,(n,v) ∈ E}, which denote the set of children of node n might include a graph API 532.
Valid nodes N_{V} ⊂ N. By definition, every node n ∈ N_{V} is always valid with respect to its target predicates. This means that for every node n ∈ N_{V}, match(Q,Lₙ) is true. In some cases (and as described below) this set n ∈ N_{V}, (where match(Q,Lₙ) is true) is the set of nodes returned by the index engine 520.
Reachable nodes N_{R} ⊂ N. The set of of nodes that are reachable, based on the results seen so far during query evaluation. By definition, every node n ∈ N_{R} has at least one valid path P leading to it. This means that every node v ∈ P is both valid and reachable, although n itself might not be valid.
Result nodes. The set the nodes desired to be returned as query results. This is exactly N_{R} ∩ N_{V}, which are the valid nodes that are reachable through valid paths.

Function toposort assigns node IDs in the order of a topological sort of G. This maintains the invariant that for any node n, its children v ∈ Cₙ come later in the node ID order. Function evaluate (see Algorithm 1) begins by adding the children of the start node s to the reachable set N_{R} (line 1). It then retrieves the first valid node with node ID greater than s from the index (line 3). If the retrieved node is already in the reachable set, then it is both reachable and valid and added to the results set (line 5). Since it is also true that its children are reachable, then the children are added to the reachable set (line 6). Resume the search using the index to retrieve the next valid node after node ID n+1. At the end of processing, return the nodes that are in the result set (line 10).

Algorithm 1: The evaluate function-query evaluation algorithm for DAGs

evaluate(s, Q)
// Returns the valid and reachable nodes.
1. reachable.add(graph.children(s));
2. nextID = s + 1;
3. while (n = index.getNextEntity(Q, nextID)) {
4. if (reachable.contains(n)) {
5. result.add(n);
6. reachable.add(children(n));
7. }
8. nextID = n + 1;
9. }
10.return result.nodes( );

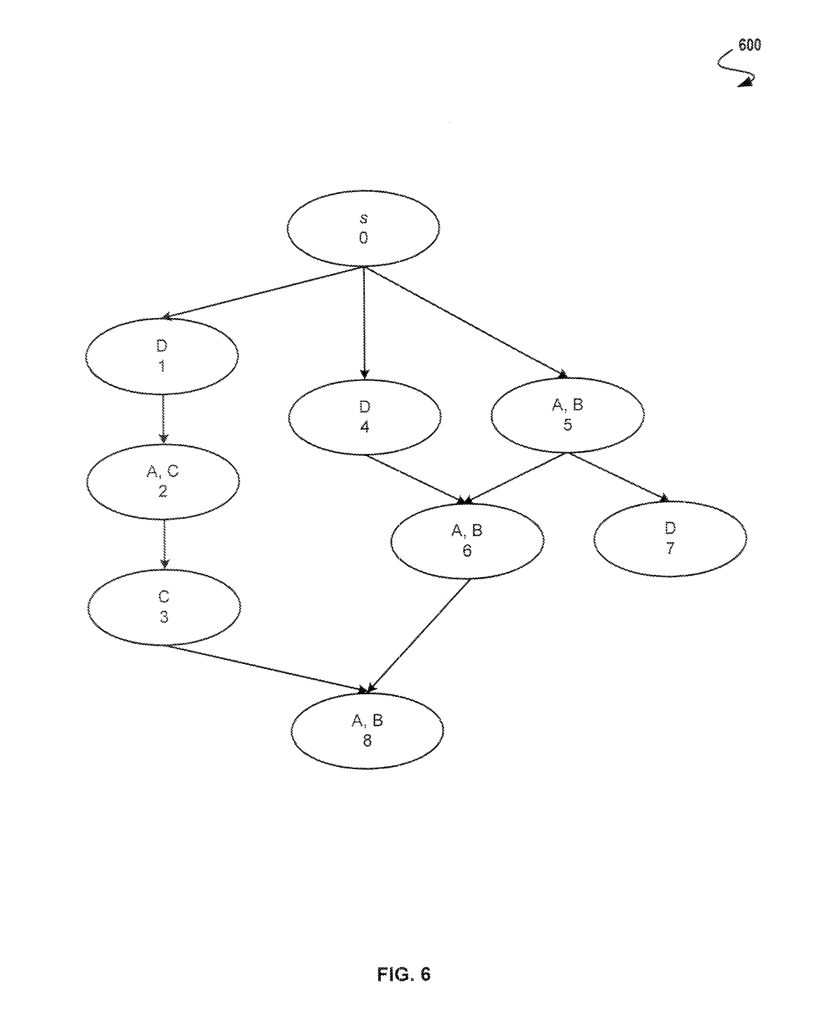

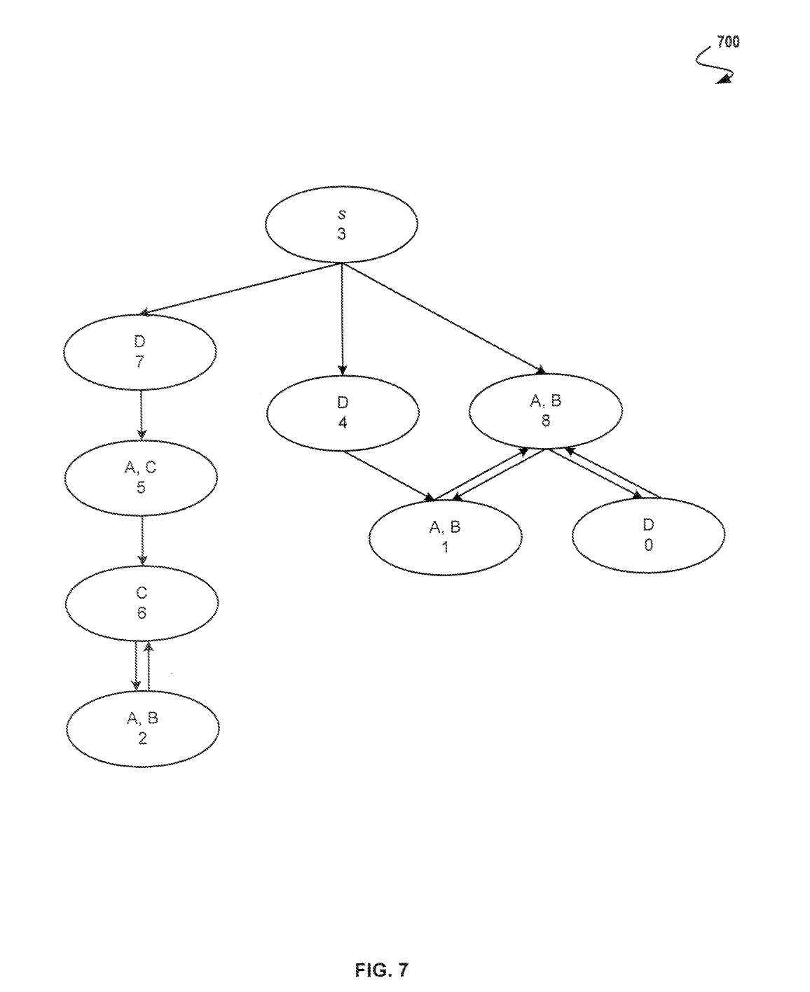

FIG. 6 shows a DAG 600 where each node is annotated with its node ID. Node IDs are assigned in topological sort order (e.g. as per the function toposort) before query evaluation starts. FIG. 6 also shows the labels associated with each node. Consider that, for this example, the start node is s=0 and the query labels are Q={A, B, C}, then function match(Q,Lₙ) semantics is “subset”, meaning that node n is valid with respect to its target predicates if and only if Lₙ ⊂ Q. Given this, the set of valid nodes N_{V} is {2,3,5,6,8}.

Table 2 shows the valid, reachable, and result sets after each valid node is returned by the index engine 520. When nodes 2 and 3 are returned by the index engine 520, they are simply discarded since they are not reachable. When node 5 is returned, it is known to be reachable, and therefore, is added to the result set along with its children. A similar scenario is shown for nodes 6 and 8.

TABLE 2
DAG example

| | N_{V} | N_{R} | N_{R} ∩ N_{V} |
|---|---|---|---|
| n | (valid) | (reachable) | (result set) |
| s = 0 | Ø | {1, 4, 5} | Ø |
| 2 | {2} | {1, 4, 5} | Ø |
| 3 | {2, 3} | {1, 4, 5} | Ø |
| 5 | {2, 3, 5} | {1, 4, 5, 6, 7} | Ø |
| 6 | {2, 3, 5, 6} | {1, 4, 5, 6, 7, 8} | {5, 6} |
| 8 | {2, 3, 5, 6, 8} | {1, 4, 5, 6, 7, 8} | {5, 6, 8} |

The table shows the state of N_{V}, N_{R} and N_{R} ∩ N_{V} after each valid node is returned by the index.
To prove the algorithm's correctness, observe the following important invariant:

Invariant 1: For any node n, let Pₙ={v ∈ N,(v,n) ∈ E} denote the set of parents of n. Then for any n ∈ N_{R} ∩ N_{V} there exists one node v ∈ Pₙ such that v ∈ N_{R} ∩ N_{V}.

Proof Assume the contrary, let n be a node so that none of the nodes v ∈ Pₙ are present in the result set. Then n cannot be reached from s using only valid nodes because none of its parents are valid.

Theorem 1: The algorithm of Algorithm 1 is correct.

Proof By sorting the nodes in order of the topological sort, it is concluded that at the time node n is examined, all of its parents already have been examined by the algorithm. Node n can be added to the reachable set if and only if one of the nodes v ∈ Pₙ was added to the result set. Therefore, n is added to the result set only if one of its parents is valid and reachable.

### Skipping During Query Evaluation Algorithm for DAGs

It is possible to speed up the DAG algorithm further by skipping in the underlying index. The following two lemmas show how to skip to the minimum element in the reachable set that is at least as big as the current node ID returned by the index.

Lemma 1: Let m be the minimum node id in N_{R}. Then no node with an id of less than m can ever be added to the result set.

Proof Consider a node k whose ID is less than m. Then when processing node k, it is known that it is not in the reachable set; therefore the reachable.contains(k) statement will fail.

Lemma 2: When processing node n, let m be the minimum id in N_{R} that is at least as big as n. Then no node with an id of less than m can ever be added to the result set.

Proof Suppose by contradiction that some node with an ID less than m should be added to the result set, and let k be such a node with the smallest ID. Clearly k must be a valid node; furthermore, one of its parents, v ∈ Pₖ must be both valid and reachable. When processing v, add Cᵥ to the reachable set. Therefore, since k ∈ Cᵥ it could not be skipped during the course of the algorithm.

The algorithm shown in Algorithm 2 (see below) implements the skipping for retrieval when G is a DAG. The changes from the Algorithm 1 are shown in line 2, where (set the next node to be retrieved by the index to be the minimum node id in the reachable set), and in line 8, (ask the index to resume searching for valid nodes after the minimum node id from the reachable set that is greater than n).

Algorithm 2: Query evaluation algorithm for DAGs with skipping

evaluate(s, Q)
// Returns the valid and reachable nodes.
1. reachable.add(graph.children(s));
2. skip = min(reachable);
3. while (n = index.getNextEntity(Q, skip)) {
4. if (reachable.contains(n)) {
5. result.add(n);
6. reachable.add(children(n));
7. }
8. skip = minMoreThan(reachable, n);
9. }
10. return result.nodes( );

Consider again the example from FIG. 6. After the index returns node 2 and it is verified that it is unreachable, it is known that the next node with an ID greater than n, and that is in the reachable set, is 4. Therefore Algorithm 2 avoids retrieving node 3 from the index. For example, given the case of n=2, the variable skip will be set to 4 (in line 8 of Algorithm 2).

### Query Evaluation Algorithm for General Graphs

A crucial invariant in the case of DAGs was that when processing a node n, all of its parents had already been processed, and thus logic concludes whether n would be reachable or not. This is not the case in general graphs that contain cycles, since no topological sort on the nodes exists (since graphs with cycles contain mutually-referencing nodes). Therefore, in addition to maintaining the reachable set, a query evaluation algorithm for general graphs explicitly maintains the valid set N_{V}, since when a node n ∈ N_{V} is returned by the index, it is not known to be reachable or not. See Algorithm 3.

In this version of the algorithm, no assumption is made about the node ID assignments, and therefore all valid nodes from the index, starting from node ID 0 (line 2), must be retrieved. Once a node n is returned by the index, evaluate adds it to the valid set (line 4). It then checks if n is reachable (line 5). If n belongs to the reachable set, it is known to be both reachable and valid and the auxiliary function updatePath is used to update the status of n and its descendant nodes.

Function updatePath starts by adding n to the result set (line 1). Then it updates the status of n's children since now it is known that they have at least one valid path leading to them through node n. This is done in lines 2-12. The status of a child node c is modified only if it is not already in the result set (line 4). This checks guarantees that function updatePath is called exactly once for each node in the result set. If c already belongs to the valid set (i.e. c was already returned by the index), then it is known to be both valid and reachable. Thus, its status through a recursive call to updatePath (line 6) is updated. If c does not belong to the valid set, it is simply added to the reachable set (line 9).

Algorithm 3:

evaluate(s, Q)
// Returns the valid and reachable nodes.
1. reachable.add(graph.children(s));
2. nextID = 0;
3. while (n = index.getNextEntity(Q, nextID)) {
4. valid.add(n);
5. if (reachable.contains(n)) {
6. updatePath(n);
7. }
8. nextID = n + 1;
9. }
10. return result.nodes( );
updatePath(n)
// Updates status of a node and its descendants.
1. result.add(n);
2. C = graph.children(n);
3. foreach c in C {
4. if (not result.contains(c)) {
5. if (valid.contains(c)) {
6. updatePath(c);
7. }
8. else {
9. reachable.add(c);
10. }
11. }
12.}

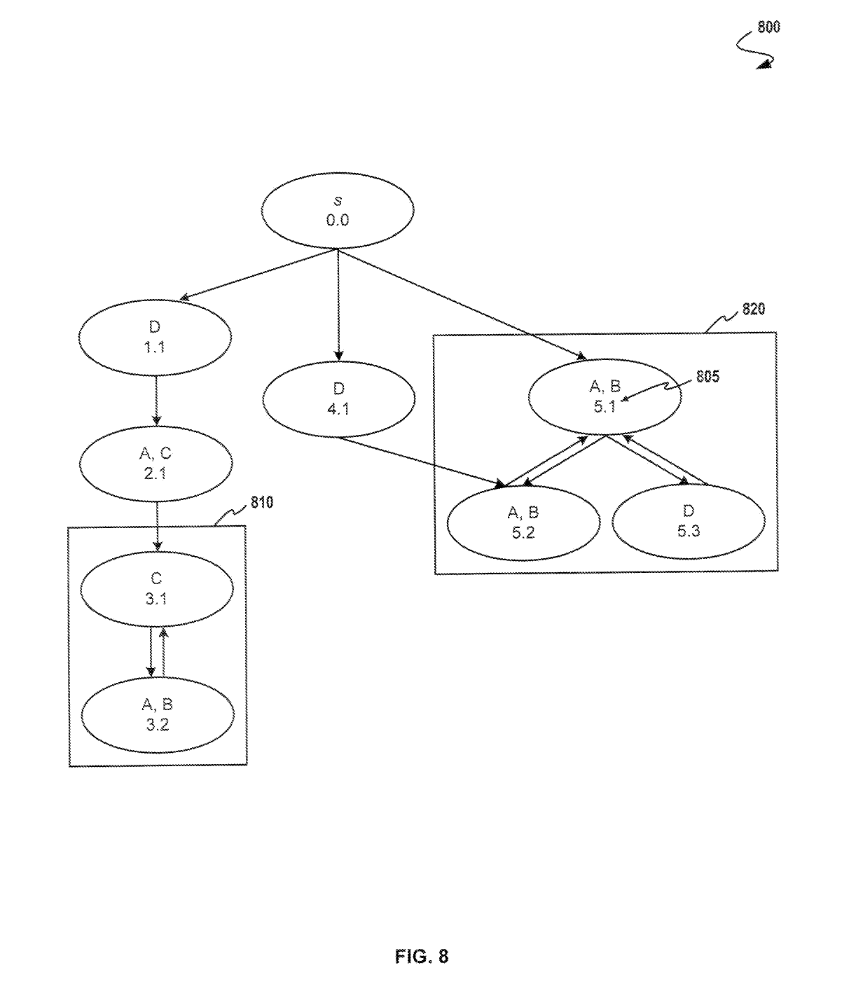

FIG. 7 shows a simple graph containing cyclic subgraphs 700 where each node is annotated with a randomly-selected node ID. This example labels each node with a randomly assigned node ID in order to emphasize the fact that the Algorithm 3 does not make any assumption about the node ID ordering. The start node s is 3 and the query labels are Q={A, B, C}, as in the previous example. The set of valid nodes N_{V} returned by the index is {1,2,5,6,8}. Table 3 shows the state of each of the node sets after the initialization of the reachable set with the children of the start node and after each call to the index method getNextEntity( ).

When nodes 1, 2, 5, and 6 are returned by the index engine, they are not in the reachable set, so they are added to the valid set. When the index engine returns node 8, which is reachable, it is added to the valid set and call updatePath, which adds 8 to the result set and its children 0 and 1 to the reachable set. Since node 1 is already valid, updatePath is called recursively and it is added to the result set as well.

TABLE 3
Cyclic graph example

| n | N_{V} | N_{R} | Result |
|---|---|---|---|
| s = 3 | Ø | {4, 7, 8} | Ø |
| 1 | {1} | {4, 7, 8} | Ø |
| 2 | {1, 2} | {4, 7, 8} | Ø |
| 5 | {1, 2, 5} | {4, 7, 8} | Ø |
| 6 | {1, 2, 5, 6} | {4, 7, 8} | Ø |
| 8 | {1, 2, 5, 6, 8} | {0, 1, 4, 7, 8} | {1, 8} |

The table shows the state of N_{V}, N_{R} and N_{R} ∩ N_{V} after each valid node is returned by the index engine.

Lemma 3: The query evaluation algorithm returns node n in a result if and only if n is valid and reachable.

Proof For n to be added to the result set, it must be returned by the index and therefore valid. Furthermore, since only the children of result nodes are added to the set of reachable nodes N_{R}, one of its parents was a result node, therefore n must be reachable as well.

To prove the converse, assume by contradiction that the lemma is false and let V be the set of valid and reachable nodes that is not returned by the algorithm. There exists some node n ∈ V such that one of its parents v ∈ Pₙ must be returned by the algorithm (otherwise none of the nodes in V can be reached from s). If v was added to the result set before processing n, then it will appear in N_{R} when processing n and therefore be added to the result set. Otherwise, n is added to the valid set N_{V}; however, when v is added to the result set, n will be marked reachable and added to the result set as well. Therefore no such n can exist.

### Skipping During Query Evaluation Algorithm for General Graphs

In the case of DAGs, the numbering of the nodes allowed the algorithm to conclude that some of the valid nodes cannot be reachable, and thus skip in the underlying index. At first glance, this is not true in the case of general graphs—that is, absent a full ordering on the nodes, a node cannot be skipped simply because it is not currently in the reachable set. In order to maintain the skipping property, first decompose the graph into strongly connected components (SCCs). Recall that, contracting each SCC into a single node the resulting graph (called the condensation of G) is a DAG, and thus it is possible to combine the skipping aspect from the DAG algorithm (Algorithm 2) as well as the recursive evaluation component from the general algorithm (Algorithm 3) to enable skipping in the case of general graph G.

As is readily understood by those skilled in the art, it is possible to decompose the graph (generalized graph G) into the SCCs, resulting in the condensation of generalized graph G, before building the index. In one embodiment, node IDs have two parts: (a) the SCC ID and (b) the ID of the node within the SCC. After decomposing the graph into SCCs, IDs are assigned to the nodes (including nodes that are SCCs) in topological sort order. Then, inside each SCC, IDs are assigned in arbitrary order.

FIG. 8 shows a graph containing cyclic subgraphs where each node is annotated with a two-part node ID 805. (Given two two-part node IDs c₁.n₁ and c₂.n₂, then c₁.n₁>c₂.n₂ [symbol] c₁>c₂ [symbol] (c₁=c₂ [symbol] n₁>n₂). In some embodiments a two-part labeling of a node is constructed with a first part c₁ being assigned an ordinal number corresponding to a topological ordering of the nodes of the condensed graph (i.e. excluding nodes within the condensed node). In some embodiments a two-part labeling of a node is constructed with a second part n₁ being assigned an ordinal number that is assigned using an arbitrary ordering. If required by the index API 522, this numbering scheme can be easily converted to simple integer IDs, e.g. by using the most significant bits to represent the SCC ID, and the least significant bits to represent the IDs within the SCC. As shown, the condensed graph 800 contains a condensed node 810 and a second condensed node 820. Each node inside a condensed node is labeled with a two-part node ID.

The full algorithm for dealing with a directed graph with two-part node IDs is given in Algorithm 4. Note the use of variable reachableSCCs to store just the component IDs from the nodes in N_{R}. The main changes from Algorithm 3 are in lines 6 and 16, where the step sets the variable skip to the minimum SCC ID in the reachable set. Also in line 16, the step makes sure the component is greater than the current component, denoted by scc. For simplicity, assume that setting skip to a given component comp will cause the index to return the next valid node with an ID greater than comp.0. Another change is to only add a node to the valid set if it belongs to a reachable component (line 8).

To reason about the skipping behavior, observe the following simple consequence of the labeling scheme.

Invariant 2: For any two nodes v, w ∈ N if there exists a path from v to w in G, then either v and w lie in the same SCC, or the SCC id of v is strictly smaller than the SCC id of w.

The invariant allows skipping unreachable SCCs in the general graph in the same manner of skipping unreachable nodes in DAGs (see Algorithm 3). To ensure correctness, below in Lemmas 4 and 5 are stated the analogues of Lemmas 1 and 2.

Lemma 4: Let cₘ.nₘ be the minimum node id in N_{R}. Then no node with an id of less than cₘ.0 can ever be added to the result set.

Lemma 5: When processing node c.n, let cₘ.nₘ be the minimum id in N_{R} that is at least as big as c.n. Then no node with an id less than cₘ.0 can ever be added to the result set.

Table 4 shows a run of the evaluate algorithm with skipping enabled. The example is the same example as in Table 3 but the graph is annotated using the two-part node ID assignment scheme. The algorithm proceeds as before, keeping a set of valid and reachable nodes, as well as the reachable SCCs. When evaluating node c.n=2.1 it is noted that the minimum reachable SCC has index=4, therefore set skip to 4.0. This allows skipping over nodes 3.1 and 3.2, which would otherwise be retrieved by the index. Otherwise stated, the evaluate algorithm with skipping enabled includes skipping index retrievals based on the next minimum reachable condensed node. Another point is that although node 2.1 is valid, the algorithm does not add it to the valid set N_{V} since at the point that it is processed it is already known that it is not reachable.

Algorithm 4: Query evaluation algorithm for the
general case with skipping

evaluate(s, Q)
// Returns the valid and reachable nodes.
1. C = graph.children(s);
2. foreach scc.v in C {
3. reachable.add(scc.v);
4 reachableSCCs.add(scc);
5. }
6. skip = min(reachableSCCs);
7. while (scc.n = index.getNextEntity(Q, skip)) {
8. if (reachableSCCs.contains(scc)) {
9. valid.add(scc.n);
10. if (reachable.contains(scc.n)) {
11. updatePath(scc.n);
12. }
13. skip = scc.n + 1;
14. }
15. else {
16. skip = minMoreThan(reachableSCCs, scc);
17. }
18. }
19. return result.nodes( );
updatePath(scc.n)
// Updates status of a node and its descendants.
1. result.add(scc.n);
2. C = graph.children(scc.n);
3. foreach comp.v in C {
4. if (not result.contains(comp.v)) {
5. reachableSCCs.add(comp);
6. if (valid.contains(comp.v)) {
7. updatePath(comp.v);
8. }
9. else {
10. reachable.add(comp.v);
11. }
12. }
13. }

TABLE 4

| scc.n | N_{V} | N_{R} | SCCs | Result |
|---|---|---|---|---|
| s = 0.0 | Ø | {1.1, 4.1, 5.1} | {1, 4, 5} | Ø |
| 2.1 | Ø | {1.1, 4.1, 5.1} | {1, 4, 5} | Ø |
| 5.1 | {5.1} | {1.1, 4.1, 5.1, 5.2, 5.3} | {1, 4, 5} | {5.1} |
| 5.2 | {5.1, 5.2} | {1.1, 4.1, 5.1, 5.2, 5.3} | {1, 4, 5} | {5.1, 5.2} |

The example of processing using Algorithm 4 proceeds after the graph G is decomposed into strongly connected components (SCCs). The column labeled SCCs is the set of reachable SCCs. After processing node 2.1 the next reachable SCC is 4, therefore the algorithm sets skip to 4.0 and nodes 3.1 and 3.2 are skipped during the processing.

### Handling Updates in the System

The algorithms herein use an index engine 520 for evaluating the targeting constraints, and rely on the graph engine 530 for checking node reachability. The inverted index 521 and the directed graph representation 531 might be built offline, possibly using an index constructor engine 580 and a graph constructor engine 570. Such data structures might be labeled as (a) currently available, and (b) currently under construction. Alternating retrievals between these two data structures implements a technique for handling updates in the system. The inverted index 521 and the directed graph representation 531 might be used by a index engine 520 and a graph engine 530 during query processing by an evaluator engine 510.

As shown in FIG. 5, a new advertising network publisher 540, and/or a new advertising network intermediary 550, and/or a new advertising network subscriber 560 might be added to the graph and index. In particular a new advertising network publisher 540 might be added to publisher database 541 (see path 542), and/or it might be provided to a graph constructor engine 570 (see path 543). Similarly, a new advertising network intermediary 550 might be added to an intermediary database 551 (see path 552), and/or it might be provided to a graph constructor engine 570 (see path 553). Of course, a new advertising network subscriber 560 might be added to subscriber database 561 (see path 562), and/or it might be provided to a graph constructor engine 570 (see path 563).

The valid node list 523, reachable node list 533, and result node list 511 are query processing data structures that are reinitialized for each query. The directed graph representation 531 can be updated in-place. Each index structure handles updates in a manner dependent on the implemented data structure. Some inverted indexes, for instance, may use a “tail” index to contain the entities added or updated since the last index build.

In some cases, depending on the index structure used to evaluate targeting, it may be sub-optimal to enforce a topological sort order for node and SCC IDs in the presence of updates. In such an instance, the generic version of the algorithm (Algorithm 4), which does not make any assumption about node and SCC ID ordering, may be employed.

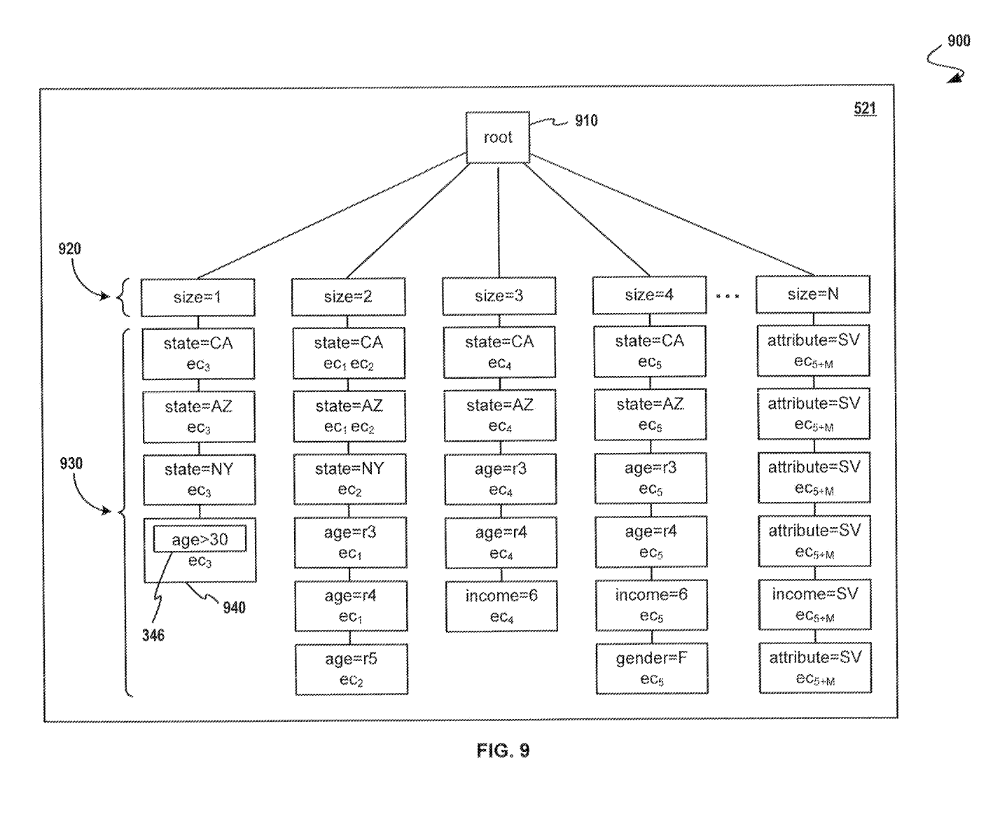

FIG. 9 shows an index with target predicates 900 in the form of an inverted index 521. As an option, the inverted index 521 may be implemented in the context of the architecture and functionality of the embodiments described herein. Of course, however, the index with target predicates 900 or any portion therefrom may be carried out in any desired environment. As shown, index with target predicates 900 in the form of an inverted index 521 comprises a tree structure stemming from an inverted index root 910 into the inverted index branches 920 (labeled as size=1, . . . size=3, . . . size=N) under which inverted index branches 920 are index predicate nodes 930. In the particular embodiment shown, the index predicate nodes 930 are labeled with a predicate (e.g. state=CA, state=AZ, etc), and with corresponding labels indicating one or more particular contracts (e.g. ec₁, ec₂, ec₃, etc) that might be satisfied with respect to the predicate of that node. For example, for the sample node 940, contract ec₃ might be satisfied (at least in part) when the target predicate 346 state=CA is true. Of course, the foregoing structure is only an illustrative example, and other structures are reasonable and envisioned.

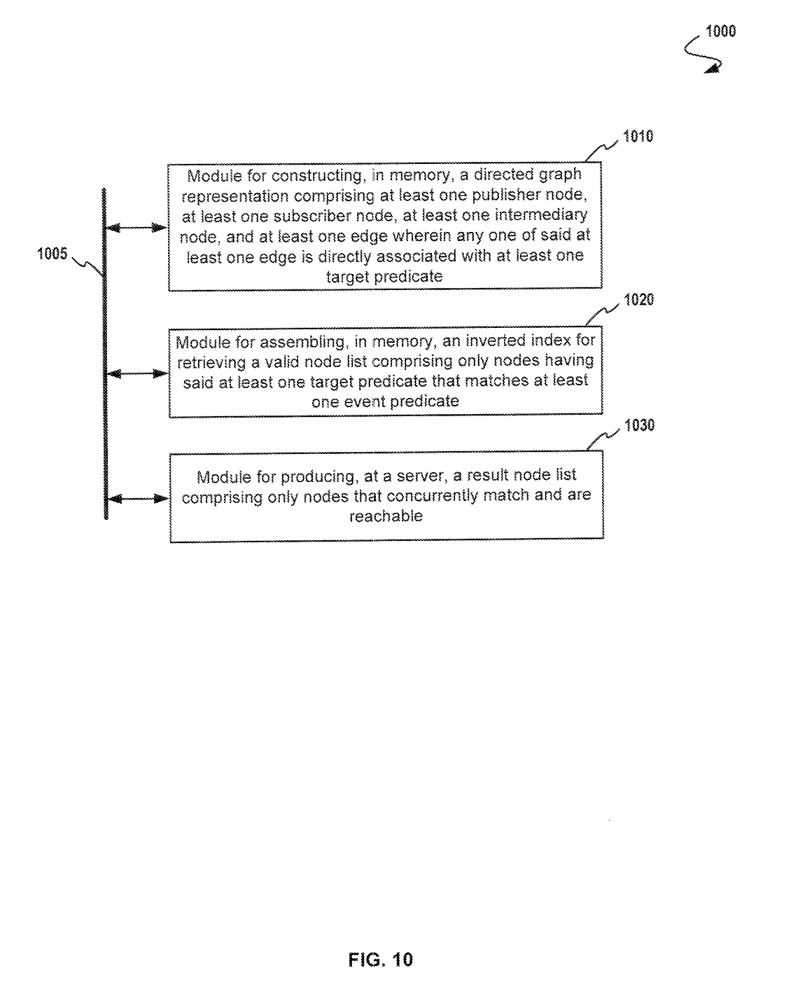

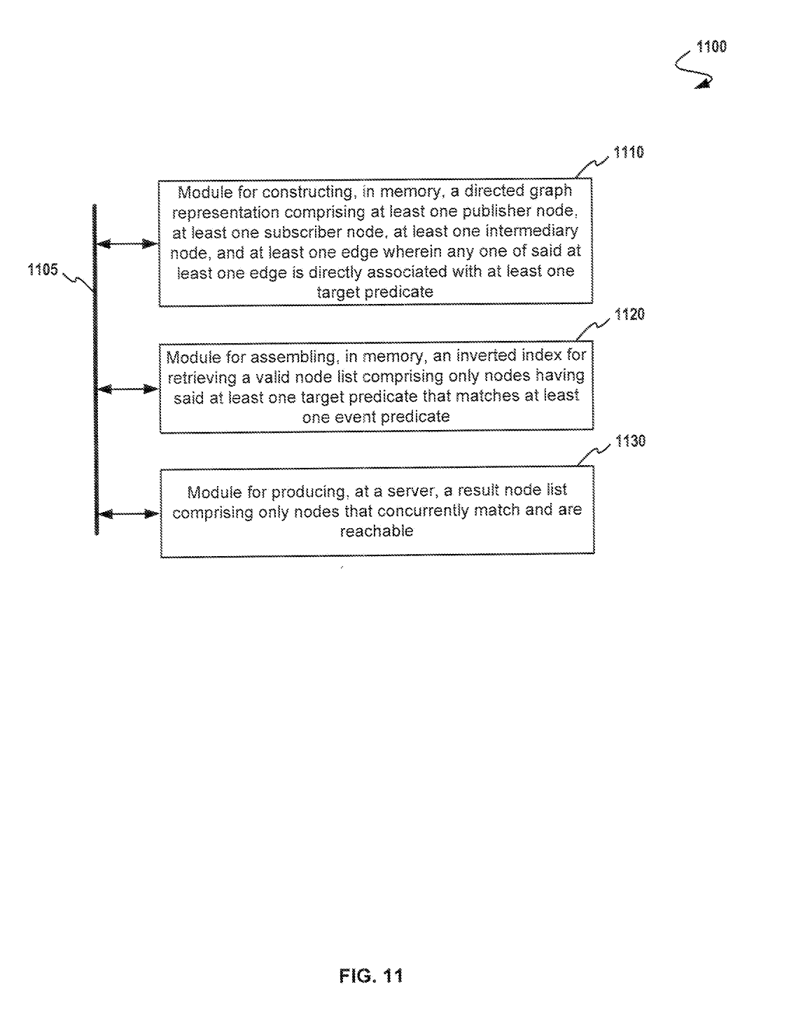

FIG. 10 depicts a block diagram of a system for automatic management of networked publisher-subscriber relationships. As an option, the present system 1000 may be implemented in the context of the architecture and functionality of the embodiments described herein. Of course, however, the system 1000 or any operation therein may be carried out in any desired environment. As shown, system 1000 includes a plurality of modules, each connected to a communication link 1005, and any module can communicate with other modules over communication link 1005. The modules of the system can, individually or in combination, perform method steps within system 1000. Any method steps performed within system 1000 may be performed in any order unless as may be specified in the claims. As shown, system 1000 implements a method for automatic management of networked publisher-subscriber relationships, the system 1000 comprising modules for: constructing, in memory, a directed graph representation comprising at least one publisher node, at least one subscriber node, at least one intermediary node, and at least one edge wherein any one of the at least one edge is directly associated with at least one target predicate (see module 1010); assembling, in memory, an inverted index for retrieving a valid node list comprising only nodes having the at least one target predicate that matches at least one event predicate (see module 1020); and producing, at a server, a result node list comprising only nodes that concurrently match and are reachable (see module 1030).

FIG. 11 depicts a block diagram of a system to perform certain functions of an advertising server network. As an option, the present system 1100 may be implemented in the context of the architecture and functionality of the embodiments described herein. Of course, however, the system 1100 or any operation therein may be carried out in any desired environment. As shown, system 1100 comprises a plurality of modules including a processor and a memory, each module connected to a communication link 1105, and any module can communicate with other modules over communication link 1105. The modules of the system can, individually or in combination, perform method steps within system 1100. Any method steps performed within system 1100 may be performed in any order unless as may be specified in the claims. As shown, FIG. 11 implements an advertising server network as a system 1100, comprising modules including a module for constructing, in memory, a directed graph representation comprising at least one publisher node, at least one subscriber node, at least one intermediary node, and at least one edge wherein any one of the at least one edge is directly associated with at least one target predicate (see module 1110); a module for assembling, in memory, an inverted index for retrieving a valid node list comprising only nodes having the at least one target predicate that matches at least one event predicate (see module 1120); and a module for producing, at a server, a result node list comprising only nodes that concurrently match and are reachable (see module 1130).

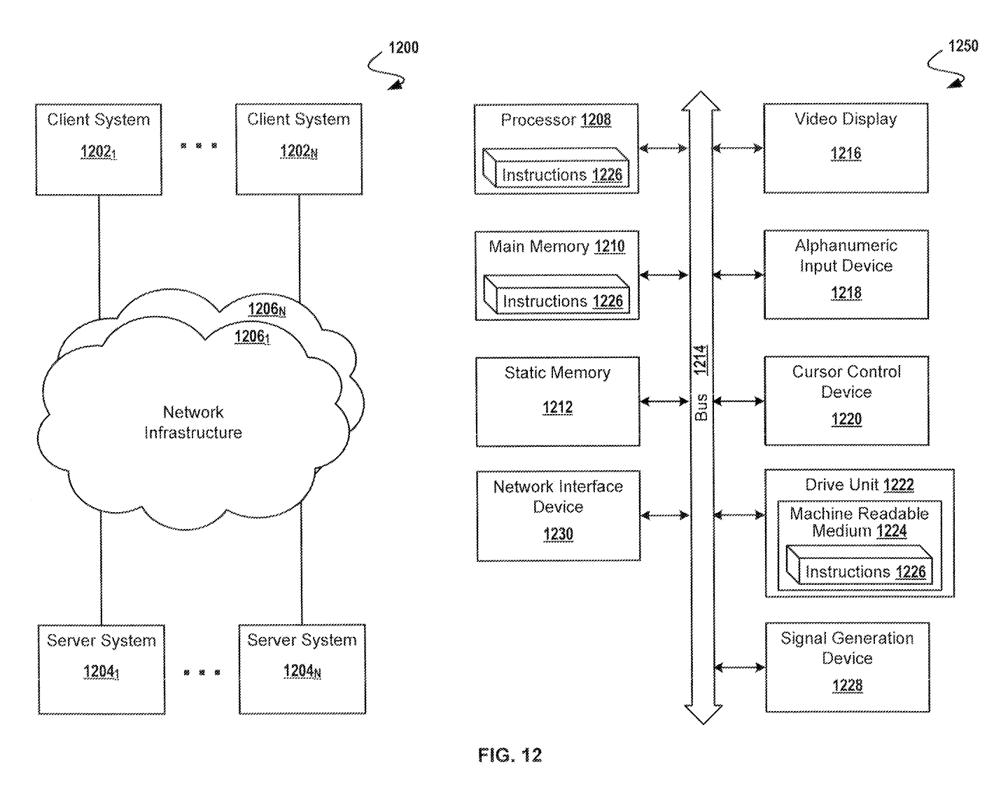

FIG. 12 is a diagrammatic representation of a network 1200, including nodes for client computer systems 1202₁ through 1202, nodes for server computer systems 1204₁ through 1204_{N}, nodes for network infrastructure 1206₁ through 1206_{N}, any of which nodes may comprise a machine 1250 within which a set of instructions for causing the machine to perform any one of the techniques discussed above may be executed. The embodiment shown is purely exemplary, and might be implemented in the context of one or more of the figures herein.

Any node of the network 1200 may comprise a general-purpose processor, a digital signal processor (DSP), an application specific integrated circuit (ASIC), a field programmable gate array (FPGA) or other programmable logic device, discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A processor may also be implemented as a combination of computing devices (e.g. a combination of a DSP and a microprocessor, a plurality of microprocessors, one or more microprocessors in conjunction with a DSP core, or any other such configuration, etc).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g. a client computer system, a server computer system) and/or may comprise one or more embedded computer systems, a massively parallel computer system, and/or a cloud computer system.

The computer system 1250 includes a processor 1208 (e.g. a processor core, a microprocessor, a computing device, etc), a main memory 1210 and a static memory 1212, which communicate with each other via a bus 1214. The machine 1250 may further include a display unit 1216 that may comprise a touch-screen, or a liquid crystal display (LCD), or a light emitting diode (LED) display, or a cathode ray tube (CRT). As shown, the computer system 1250 also includes a human input/output (I/O) device 1218 (e.g. a keyboard, an alphanumeric keypad, etc), a pointing device 1220 (e.g. a mouse, a touch screen, etc), a drive unit 1222 (e.g. a disk drive unit, a CD/DVD drive, a tangible computer readable removable media drive, an SSD storage device, etc), a signal generation device 1228 (e.g. a speaker, an audio output, etc), and a network interface device 1230 (e.g. an Ethernet interface, a wired network interface, a wireless network interface, a propagated signal interface, etc).

The drive unit 1222 includes a machine-readable medium 1224 on which is stored a set of instructions (i.e. software, firmware, middleware, etc) 1226 embodying any one, or all, of the methodologies described above. The set of instructions 1226 is also shown to reside, completely or at least partially, within the main memory 1210 and/or within the processor 1208. The set of instructions 1226 may further be transmitted or received via the network interface device 1230 over the network bus 1214.

It is to be understood that embodiments of this invention may be used as, or to support, a set of instructions executed upon some form of processing core (such as the CPU of a computer) or otherwise implemented or realized upon or within a machine- or computer-readable medium. A machine-readable medium includes any mechanism for storing or transmitting information in a form readable by a machine (e.g. a computer). For example, a machine-readable medium includes read-only memory (ROM); random access memory (RAM); magnetic disk storage media; optical storage media; flash memory devices; electrical, optical or acoustical or any other type of media suitable for storing information.

We claim:

1. A computer-implemented method for automatic management of networked publisher-subscriber relationships, the method comprising:
constructing, in memory, a directed graph representation comprising at least one publisher node, at least one subscriber node, at least one intermediary node, and at least one edge wherein any one of said at least one edge is directly associated with at least one target predicate;
assembling, in memory, an inverted index for retrieving a valid node list comprising only nodes having said at least one target predicate that matches at least one event predicate; and
producing, at a server, a result node list comprising only nodes that concurrently match and are reachable.

2. The method of claim 1, further comprising:
receiving, at a server at least one event predicate.

3. The method of claim 1, wherein producing the results node list does not evaluate a valid node from the valid node list for matching the target predicate when the valid node is unreachable.

4. The method of claim 1, wherein the constructing comprises labeling a node of the directed graph representation using an ordinal number corresponding to a topological ordering.

5. The method of claim 1, wherein the directed graph representation contains at least one cyclic subgraph.

6. The method of claim 1, wherein the directed graph representation is a condensed graph representation having at least one condensed node.

7. The method of claim 6, wherein the constructing comprises two-part labeling of a condensed node.

8. The method of claim 7, wherein the two-part labeling of a node of the condensed graph representation uses an ordinal number corresponding to a topological ordering excluding nodes within the condensed node.

9. The method of claim 8, wherein the producing the result node list includes skipping index retrievals based on the next minimum reachable condensed node.

10. An advertising server network for automatic management of networked publisher-subscriber relationships comprising:
a module for constructing, in memory, a directed graph representation comprising at least one publisher node, at least one subscriber node, at least one intermediary node, and at least one edge wherein any one of said at least one edge is directly associated with at least one target predicate;
a module for assembling, in memory, an inverted index for retrieving a valid node list comprising only nodes having said at least one target predicate that matches at least one event predicate; and
a module for producing, at a server, a result node list comprising only nodes that concurrently match and are reachable.

11. The advertising server network of claim 10, further comprising:
receiving, at a server at least one event predicate.

12. The advertising server network of claim 10, wherein producing the results node list does not evaluate a valid node from the valid node list for matching the target predicate when the valid node is unreachable.

13. The advertising server network of claim 10, wherein the constructing comprises labeling a node of the directed graph representation using an ordinal number corresponding to a topological ordering.

14. The advertising server network of claim 10, wherein the directed graph representation contains at least one cyclic subgraph.

15. The advertising server network of claim 10, wherein the directed graph representation is a condensed graph representation having at least one condensed node.

16. The advertising server network of claim 15, wherein the constructing comprises two-part labeling of a condensed node.

17. The advertising server network of claim 16, wherein the two-part labeling of a node of the condensed graph representation uses an ordinal number corresponding to a topological ordering excluding nodes within the condensed node.

18. The advertising server network of claim 17, wherein the producing the result node list includes skipping index retrievals based on the next minimum reachable condensed node.

19. A computer readable medium comprising a set of instructions which, when executed by a computer, cause the computer to perform automatic management of networked publisher-subscriber relationships the instructions for:
constructing a directed graph representation comprising at least one publisher node, at least one subscriber node, at least one intermediary node, and at least one edge wherein any one of said at least one edge is directly associated with at least one target predicate;
assembling an inverted index for retrieving a valid node list comprising only nodes having said at least one target predicate that matches at least one event predicate; and
producing a result node list comprising only nodes that concurrently match and are reachable.

20. The computer readable medium of claim 19, further comprising:
instructions for receiving at least one event predicate.
